(19) United States
(12) Patent Application Publication
(10) Pub. No.: US 2009/0130772 A1
(43) Pub. Date: May 21, 2009

(54) Apparatus and method for collecting data on light-emitting reactions

(76) Inventors: Kauko Lehtinen, Naantali (FI); Petri Kivela, Piispanristi (FI)

Correspondence Address: KUBOVCIK & KUBOVCIK, SUITE 1105, 1215 SOUTH CLARK STREET, ARLINGTON, VA, 22202, US

(21) Appl. No.: 11/984,332

(22) Filed: Nov. 15, 2007

(51) Int. Cl. G01N 21/76

(52) U.S. Cl. 436/172; 422/52

(57) ABSTRACT

The invention concerns an apparatus and a method for collecting data on a set of light-emitting molecular reactions. The apparatus comprises a holder for a reaction vessel comprising a plurality of reaction spaces containing first reaction substance, feeder for supplying second reaction substance to said reaction spaces for initiating said reaction set, and a plurality of light detectors for measuring light emitted from said reaction spaces in synchronized relationship with said feeding. According to the invention, at least two of said light detectors are arranged on opposing sides of the reaction vessel and being adapted to simultaneously measure different properties of the reaction set, that is, different wells or wavelengths, for example. The invention allows doubling the measurement speed in aequorin-based intracellular Ca-measurements.

The invention relates to chemical and biomedical analyses. In particular, the invention concerns an apparatus and method for collecting data on molecular reactions taking place in a reaction vessel, such as a microtiter plate, comprising a plurality of reaction spaces. The method comprises feeding reactant to the reaction spaces for initiating the reactions, and measuring light emitted from said reaction spaces during the reactions.

Bioluminescence refers to the emission of light by biological molecules. Bioluminescent proteins can be enzymes such as luciferases, which catalyze the oxidation of luciferin, emitting light and releasing oxyluciferin, photoproteins, which catalyze the oxidation of luciferin to emit light but do not release the oxidized substrate or photoproteins, which do not involve luciferin-luciferinase system, and the reaction proceeds in the absence of oxygen. Examples of bioluminescent proteins include those isolated from the ctenophores Mnemiopsis (mnemiopsin) and Beroe ovata (berovin), those isolated from the coelenterates Aequoria (aequorin), Obelia (obelin), Pelagia, and luciferases such as Renilla (Renilla luciferase) and those isolated from the molusca Pholas (pholasin). Bioluminescent proteins also can be isolated from ostracods such as Cypridina.

Aequorin is a photoprotein that originates from the jellyfish Aequorea Victoria. The apoenzyme (apoaequorine) is a 21 kD protein, and needs a hydrophobic prosthetic group, coelenterazine, to be converted to aequorin which is the active enzyme. Upon calcium binding, aequorin oxidizes coelenterazine into coelenteramide with production of CO₂ and emission of light. The affinity of aequorin to calcium is in the low micromolar range, and the activity of the enzyme is proportional to calcium concentration in the physiological range (50 nM to 50 μM). Through the measure of light emitted upon oxidation of coelenterazine, aequorin provides a reliable tool, in the measure of calcium concentration, and gives results which are comparable to those determined with fluorescent dyes.

Ca²⁺ assays can be carried out using a so-called aequorin method. Aequorin is sensitive to intracellular Ca²⁺ level of biological cells. More specifically, aequorin comprises a hydrophobic coelenterazine molecule as a prosthetic group, the molecule being easily taken up across plant and fungal cell walls, as well as the plasma membrane of higher eukaryotes. During this process, Ca²⁺ atoms trigger Aequorin to emit detectable light. This makes aequorin suitable as a Ca²⁺ (calcium) reporter in plants, fungi and mammalian cells.

G protein-coupled receptors (GPCRs) represent a large family of seven transmembrane domain proteins functionally coupling to G proteins for signal transduction. Upon binding of the agonists, GPCRs induce release of GDP by the associated Gα protein and binding of a molecule of GTP, causing dissociation of the heterotrimer into α and βγ dimer. Alpha and βγ dimmers can then associate with diverse groups of effector units carrying on the intracellular signal initiated by GPCR activation.

An aequorin-based AequoScreen™ system is available from Euroscreen. In the system, the GPCR of interest is expressed in a cell line co-expressing mitochondrially-targeted apoaequorin (Further details in: AequoScreen™ platform for high-throughput screening of GPCRs, Euroscreen s.a. Rue Adrienne Bolland 47, B-6041 Gosselies, Belgium).

Bioluminescence does not typically start instantly. For, example, photon emittance in aequorin processes typically starts after a few seconds after the mixing of the cells and aequorin. The process lasts for a considerable time period, typically 15 to 30 seconds. Because the light intensity is very low, very sensitive detectors have to be used. Photomultiplier tubes (PMT's) are found to be suitable in this respect.

In addition to using sensitive detectors, light is usually collected for essentially the whole process period in order to obtain information on the temporal behaviour of the calcium levels or in order to obtain sufficient cumulative exposure for accurate analysis. Measurement of a single well of a microtiter plate is usually carried out over the whole reaction period, that is for at least 15 seconds, typically for 20-30 seconds. The time behaviour of the calcium levels is typically of interest when new measurement setups (e.g., new cells or modified external conditions) are used, while integrating light metering is mainly employed in routine analyses.

Due to practical reasons, the dimensions of photomultiplier tubes can not be reduced to a level corresponding to dimensions of microwells is microtiter plates, that are nowadays required for performing extensive analyses. Increasing the number of PMT's to correspond to the number of individual wells, even if possible, would be undesirable because of the increased costs of the measurement apparatuses. Therefore, the throughput times of aequorin measurements are by nature relatively high.

It is an aim of the invention to overcome at least some of the problems described above and to provide a faster analysis apparatus and method for performing biomedical assays requiring a number of subsequent and relatively long continuous measurement periods.

It is a further aim of the invention to provide an improved measurement solution for assays the measurement cycle of which is defined mainly by the reaction kinetics, such as for GPCR studies and the like.

Another aim of the invention is to provide a method for aequorin-based Ca²⁺-measurements and other luminescence or liquid scintillation measurements of that kind, which considerably improves throughput times of measurements, when a full set of photon-emitting reactions in a microtiter plate is carried out.

The invention is based on the idea of providing light detectors on opposing sides of the reaction vessel such that different properties of the ongoing reaction set, that is, typically light emitted from different wells of the vessel (spatial discrimination) or different wavelengths emitted from a single well (wavelength discrimination), can be measured simultaneously.

The apparatus according to the invention comprises a holder for a reaction vessel comprising a plurality of reaction spaces containing first reaction substance (e.g., aequorin-containing liquid), a feeder adapted to supply second reaction substance (e.g., cells) to said reaction spaces for initiating the reaction set, and a plurality of light detectors for measuring light emitted from the reaction spaces in synchronized relationship with said feeding. At least two of said light detectors are arranged on opposing sides of the reaction vessel and being adapted to simultaneously measure different properties of the reaction set.

According to one embodiment, the measurement is carried out using one wavelength band only and the upper and lower detectors can be arranged to measure different wells simultaneously.

According to one embodiment, light is emitted at two wavelength ranges of interest and the detectors are provided with respective wavelength filters and arranged to simultaneously measure light from the same well.

The method according to the invention comprises feeding second reaction substance to a plurality of reaction spaces of a reaction vessel, measuring light emitted from said reaction spaces, the measuring being synchronized with said feeding and comprising measuring two different properties of the reaction set simultaneously from opposing sides of the reaction vessel.

According to one embodiment, photomultiplier tubes are used as the light detectors. The detectors can be arranged in a bank of several PMT's, the bank being capable of measuring several wells from each side of the reaction vessel simultaneously. Thus, the bank can extend over the whole width/length of an SBS standard plate, whereby movement of the detectors/vessel with respect to each other in only one dimension in required in order to measure the whole plate.

According to one embodiment, a mask or masks is/are provided between the reaction vessel and the light detectors for allowing selection of the well to be measured. This embodiment can be employed in the usual situation where the footprint of the light detectors is larger than that of individual wells, as is the case typically when PMT's are used. Thus, the masks are arranged to block radiation originating from some of the wells but allowing or guiding radiation from some other wells (one well per a detector). The mask can be in the form of a plate comprising a grid of apertures, such as holes or windows, the pitch of the grid typically corresponding to a multiple of the well-to-well pitch of the microtiter plate used. At least one of the mask plates can be movably attached to the apparatus for allowing on-line selection of the wells to be measured.

The measurement is carried out using a clear-bottomed plate. According to one embodiment, the plate is opaque-walled. According to one aspect, the measurement comprises the stages of:
providing a microtiter plate comprising a plurality of wells comprising reporter molecules,
apportioning the cells under investigation from above to at least two wells,
immediately after apportioning, measuring scintillations from the at least two wells by two scintillation detectors, one from above and the other from below.

The measuring equipment can comprise a plate holder and two masking members that are situated above and below the plate. In each of the masking members, there is an aperture, which is during the measurement in the corresponding measurement place, i.e., aligned with the open or closed end of the well to be measured from the respective side. Measurement heads of the light detectors are further aligned with the apertures (though not necessarily being concentric with the axes of the wells). The masking members may provide a direct light pathway from the wells to the detectors or comprise optical fibers for guiding light. The purpose of the masks is to cause light to be guided only from the wells to be measured to the detectors.

According to one embodiment, the feeder and the upper and lower light detector(s) are operated synchronously, that is, the light detection is begun within a certain time limit after feeding. According to a particular embodiment, the time limit is 3-5 seconds. This time limit is suitable for aequorin measurements.

In one aspect, individual reactions or reaction subsets of the reaction set are initiated at different points of time by controlling the feeder and the location of the plate with respect to the feeder.

The invention provides considerable advantages. By means of the invention, the total measurement time of a full set of samples in a microtiter plate can be at least halved, compared with previous measuring techniques. Traditionally, only 96-well microtiter plates have been used in Ca²⁺-measurements because of the slowness of the system. The present invention allows for 384-well plates and even more dense plates to be measured during reasonable periods.

In addition, a single feeding nozzle can be used for feeding cells to two different wells, which reduces the total costs of the device. Thus, the number of feeding nozzles and pumps associated with each nozzle can be significantly reduced.

An apparatus suitable for carrying out the present method can be relatively easily converted from existing liquid scintillation apparatuses, in particular those adapted to normally perform coincidence measurements. Such apparatuses have two opposing photomultiplier tubes aligned with each other, both of the tubes measuring a single property of the reaction, i.e., a single well at a single wavelength. Thus, the apparatus according to the invention may be used for coincidence measurements also with minor modifications to the measurement setup.

In addition to aequorin and other cell membrane receptor activation/passivation studies, the invention is also suitable for other kinetic biomedical and chemical studies.

It is also to be noted that the present apparatus and method, the measuring of light and the feeding of the sample wells is carried out in certain timely relationship with said feeding (i.e., synchronizedly). This is because it is the feeding that initiates the photon emittance, which, after feeding is determined by the chemistry and/or biophysics of the process, i.e., the properties of the reactants in the sample and process conditions. Due to this self-illuminating property of the reaction, no external light sources are needed, or they may be inactive during the measurement, contrary to conventional luminescence/fluorescence detection.

The term “reaction set” is used to describe the time series of individual reactions initiated by the sequential feeding of the second reaction substance to the reaction spaces. “Properties” of the reaction set include, in particular, the spatial and temporal occurrence of the individual reactions (e.g., light emitted from different wells, in which reactions are initiated sequentially) and the wavelengths emitted by the individual reactions (e.g., different bands of light spectrum emitted from a single well or different wells).

Next, embodiments of the invention are described more closely with reference to the attached drawings. In the drawings

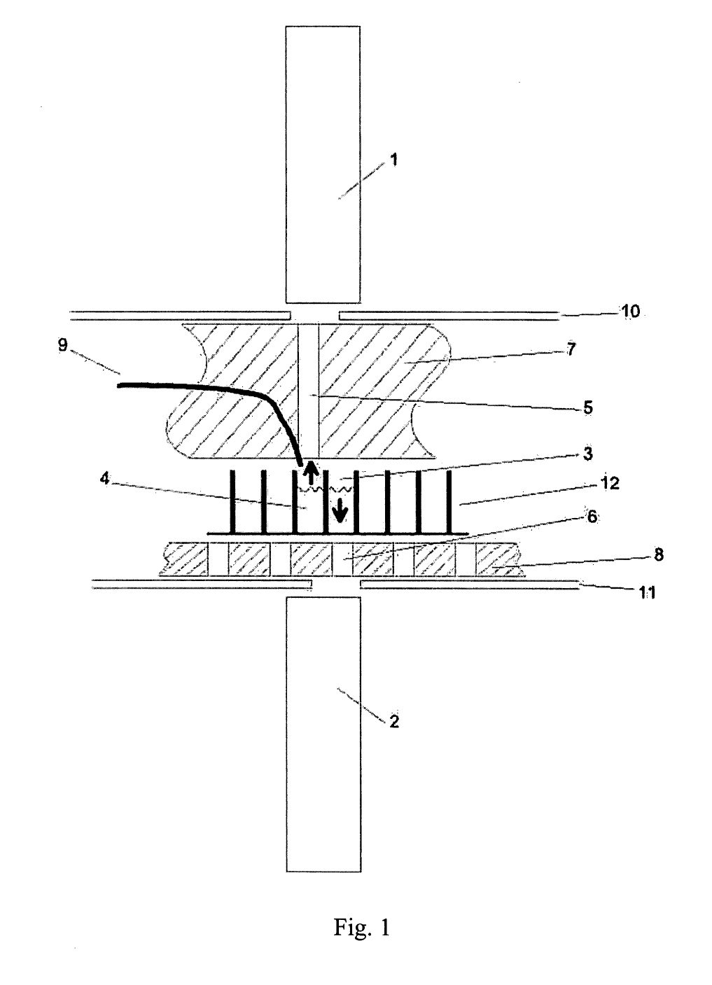

FIG. 1 shows a configuration used for measuring two neighboring wells simultaneously according to one embodiment of the invention,

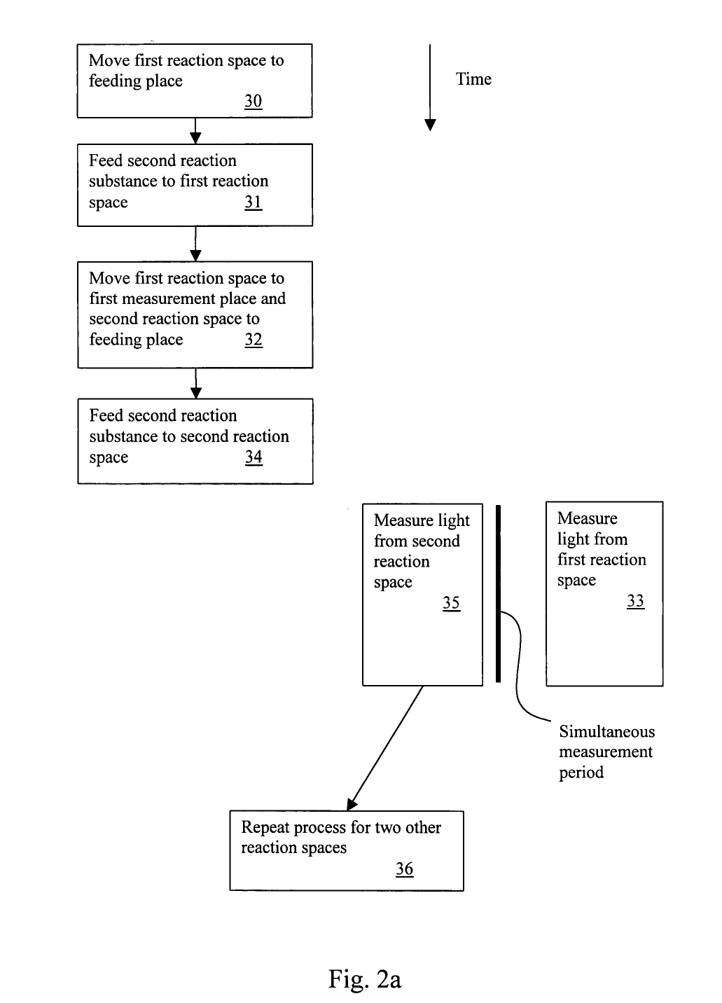

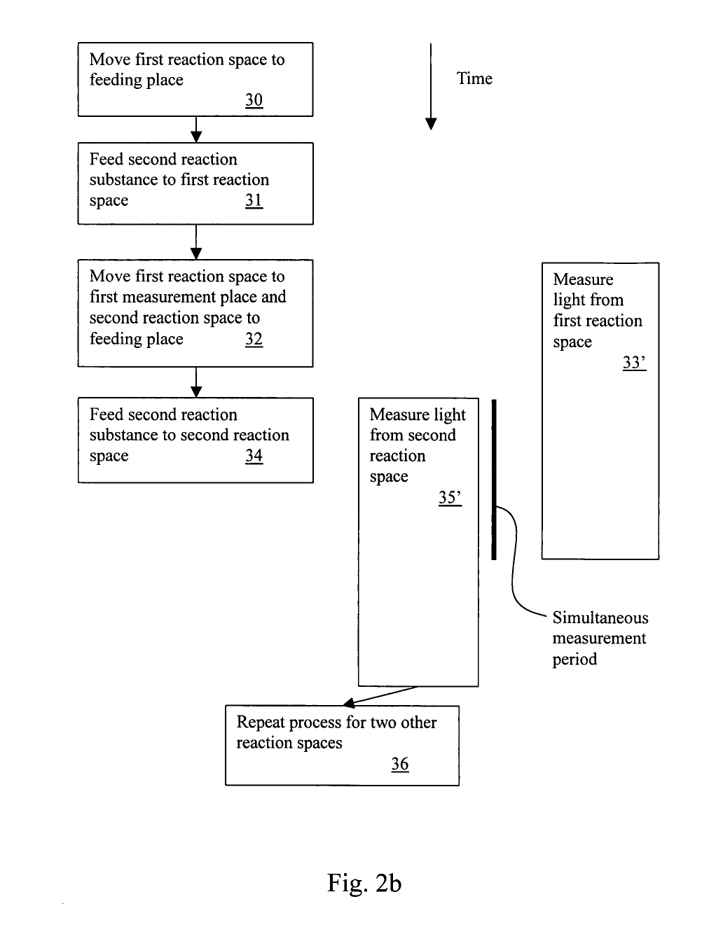

FIG. 2a illustrates the method of the invention according to one embodiment, and

FIG. 2b illustrates the method of the invention according to an alternative embodiment.

As illustrated by FIG. 1, according to one embodiment of the invention, two photomultiplier tubes (PMTs) 1, 2 are arranged on upper and lower sides of the reaction vessel. The PMTs are adapted to simultaneously measure different wells, in this case neighboring wells, by means of masks 7, 8, which contain non-aligned apertures 5, 6 for allowing light to pass from the wells 4, 3, respectively, to the PMTs 1, 2.

According to one embodiment, first of the masks (mask 7 in FIG. 1) contains only a single aperture, which is on the same side as and in fixed position with the feeding nozzle 9. The second mask (mask 8 in FIG. 1) contains a plurality of apertures in a grid, the pitch of which is twice the pitch of the vessel. Therefore, the other mask 8 can be moved with the vessel, when the vessel if moved from one feeding/measurement position to another. Thus, the mask 8 can serve as or be part of a movable holder designed to accommodate the vessel during the measurement. Alternatively, also the second mask can contain only one aperture, whereby the vessel and the second mask are movable with respect to each other in order to allow measuring all the wells of the plate.

The masks 7, 8 are designed to allow light from only the well to be measured to enter the PMTs 1, 2, while blocking other rays of light. The material of the masks is light-impermeable. The material may also be light-absorbing.

As shown in FIG. 1, the feeding nozzle 9 can be at least partly arranged within the upper mask 7 such that in every measurement position of the vessel, the nozzle 9 and the aperture 5 are directed to a single well 4.

Additional masking plates 10, 11 may also be provided between the vessel 12 and the PMTs 1, 2. In a particular embodiment, the additional masking plates are provided between the first masks 7, 8 and the PMTs 1, 2, respectively The purpose of the additional masking plates is to allow choosing of microtiter plates 12 of various sizes, shapes or pitches to be used. As shown in FIG. 1, the lower additional plate 11 prevents light from the well situated two wells left from the well to be measured from entering the lower PMT 2 despite the relatively large footprint of the PMT 2. Thus, actively movable masking plates 10, 11 allow for choosing an aperture corresponding to the footprint of the wells of the microplate used and the exact measurement position.

The disclosed configuration, where the PMTs are aligned with each other and the wells to be measured are chosen with separate masks allow for the apparatus be used also as a coincidence measurement device by removing the masks or aligning of the masks with each other and by reprogramming the device for coincidence detection. On the other hand, the present apparatus can be modified from existing coincidence measurement devices by adding suitable masks and reprogramming the apparatus to perform the required measurement sequence.

According to one embodiment, the holder of the reaction vessel comprises a frame shaped so as to accommodate a microtiter plate or the like. The frame can be movably mounted to the apparatus. The movement can take place either in one or two dimensions. In one aspect, the frame is adapted to receive a plate conforming to the SBS standard for microtiter plates.

According to one embodiment, the feeder comprises a conduit portion generally parallel to the plane of the vessel, and a nozzle portion arranged in angular position with respect to the conduit portion and directed so as to feed the reaction spaces placed below it from above. Several such conduits and nozzles are arranged in parallel for achieving a feeder capable of supplying liquid to several wells simultaneously.

The apparatus may comprise a control unit, which is adapted to adjust the relative position of the reaction vessel and the feeding nozzles/light detectors according to a predefined measurement sequence, as well as to control the feeder, light detectors and, optionally, any movable masks.

The light detectors can be connected to a computer or the like for viewing, storing and/or analyzing the measurement data.

In addition to PMTs, also other kinds of light detectors, for example, semiconductor detectors, may be employed. However, the performance of PMTs has been found to be superior to other detectors of the same cost level.

The measurement process according to one embodiment of the invention comprises (references to FIG. 1):
Apportioning a first sample under investigation from above to a first well 3.
Moving the first well 3 to a first measurement position, the first sample being in optical connection with a lower light detector 2 through the bottom of the well 3.
Apportioning a second sample under investigation from above to a second well 4.

During apportioning the second sample, the second well 4 is can be in a second measurement position, where the second sample is in optical connection with an upper light detector 1 through an open upper end of the well.
Measuring, after the apportioning, luminescence from the two wells 3, 4: the first well 3 with the lower detector 2 and the second well 4 with the upper detector 1.

The temporal progress of the method is exemplified in FIG. 2a (time duration of the objects not in relation to each other). After the first reaction space is moved into feeding place (step 30), in can be fed with cells to be measured (stage 31). Then the vessel is moved such that feeding of the second reaction space and measuring of the first one is possible (step 32). After that, the second reactions space is fed with cells (step 34) and the measurement of the first and second reaction spaces is begun (steps 33 and 35) at the same time or nearly at the same time. After the measurement, the process is repeated for wells not yet fed or measured (step 36).

FIG. 2b shows a variation of the process of FIG. 2a. In this embodiment, the measurement of the first reaction space (step 33′) is begun right after it has been fed, that is, before the second reaction space is ready to be measured. Measuring may begin during feeding or during movement of the vessel, provided that the light detector and/or the corresponding masking member is movable. This embodiment allows beginning of measurement from both wells after a constant time after feeding. Therefore, alto the measured light intensities are temporally comparable with each other.

The light intensities of the upper and lower measurement places may calibrated taking into account the usually different attenuation factors of the respective optical pathways (e.g., transmittance of the bottom of the well, diameters/lengths of the mask apertures etc.) and possibly different amplification factors of the detectors.

Measuring of the first well 3 can begin before, during of after apportioning of the second well 4. That is, the measurement can be begun even before the first well 3 is in the final steady measurement position, provided that the lower detector 2 and/or lower mask 6, 8 is moved together with the vessel accordingly.

A variation may be used, in which the tasks of the upper and lower detectors are interchanged, that is, the upper detector is adapted to measure light from the first well and vice versa.

The wells to be simultaneously measured need not be neighboring, although this embodiment provides for short movement distances and thus short dead time. Opacity of the well walls other than the bottom wall, of course, prevents cross-talk between the wells. A number of microtiter plates suitable for the present method and apparatus are available from various manufacturers.

According to one embodiment of the invention, sample mixtures are initially apportioned to more than two, for example, to ten or more reaction spaces, after which the reaction spaces are measured from above and below two at a time for a short time. The measuring process may be repeated for one or more times, such that each of the sample spaces is measured for several subsequent short periods during the assay. For example, each reaction space may be measured once a second for 30 s, i.e., 30 times altogether (for example, to cover essentially the whole temporal behaviour of aequorin-based Ca-measurements). Between the measurements, the plate is rapidly moved back and forth with respect to the detectors for moving each reaction space to measurement position for a predefined number of times. During light detection, the plate is held in place for the detection time, typically for 10-1000 ms, before moving to the next measurement position.

It has to be noted that in all of the previous and following embodiments, several feeding nozzles and light detector pairs can be driven in parallel in order to maximize the readout speed. That is, there is a bank of upper light detectors, a bank of lower light detectors and a bank of feeding nozzles (and typically also feeding pumps) in the direction perpendicular to the plane of FIG. 1.

In conventional systems, 12 PMTs and feeding nozzles can be fitted within the dimensions of a standard-sized (SBS-sized) microtiter plate. In the present system, 24 PMTs and 12 feeding nozzles driven in the manner described above provide the benefit of doubling the measurement speed but keeping the costs of the system at a reasonable level.

According to a second principal embodiment of the invention, the PMTs are arranged to measure different wavelengths from a single of from different wells. For that purpose, the device is provided with corresponding optical wavelength filters between the vessel and the upper and lower PMT, respectively. Bioluminescence Resonance Energy Transfer (BRET) is an example of an application, which can take advantage of this embodiment. In BRET, after apportioning the cells, the sample emits light on two distinct wavelengths (donor wavelength 480 nm and acceptor wavelength 520 nm). If only a single well is measured at a time, no two-stage apportioning is needed.

It is to be understood that the amount and relative positioning of the light detectors may vary, provided that the device is programmed accordingly to allow for measurement of the whole vessel. Thus, in addition to a linear row-by-row analysis, where the sample vessel is moved in one dimension, the device can, for example, be designed such that a single light detector, on each side of the vessel, is used for successively measuring also two or more columns of the vessel, whereby the sample vessel is moved in two dimensions during the measurement.

The embodiments described above and the attached drawings are for exemplifying and illustrative purposes only and are not intended to limit the scope of the invention.

1. An apparatus for collecting data on a set of light-emitting molecular reactions, comprising
a holder for a reaction vessel comprising a plurality of reaction spaces containing first reaction substance,
feeder for supplying second reaction substance to said reaction spaces for initiating said reaction set, and
a plurality of light detectors for measuring light emitted from said reaction spaces in synchronized relationship with said feeding,
wherein
at least two of said light detectors are arranged on opposing sides of the reaction vessel and adapted to simultaneously measure different properties of the reaction set.

2. An apparatus according to claim 1, wherein said two light detectors are adapted to measure light at different wavelength ranges, typically from a single reaction space.

3. An apparatus according to claim 1, wherein said two light detectors are adapted to measure light from different reaction spaces, typically at the same wavelength range.

4. An apparatus according to claim 1, which comprises
a first bank of first light detectors arranged on top of said reaction vessel and operated in parallel to measure a first property of the reaction set, and
a second bank of second light detectors arranged below said reaction vessel and operated in parallel to measure a second property of the reaction set.

5. An apparatus according to claim 4, wherein said first property is the amount of light emitted from reaction spaces in a first row of reaction spaces of said reaction vessel and said second property is the amount of light emitted from reaction spaces in a second row of reactions spaces of said reaction vessel, the second row being different than the first row, typically a neighboring row.

6. An apparatus according to claim 1, wherein the light detectors are photo multiplier tubes.

7. An apparatus according to claim l, which is adapted to
feed said second reaction substance to a first reaction space,
begin measuring of light from said first reaction space from a first side of the reaction vessel,
feed said second reaction substance to a second reaction space, typically neighboring the first reaction space,
begin measuring of light from said second reaction space from a second side of the reaction vessel,
carry on simultaneous light measurements of said first and second reaction spaces.

8. An apparatus according to claim 1, which comprises masks on opposing sides of the reaction vessel, the masks defining light pathways between single reaction spaces and single light detectors.

9. An apparatus according to claim 8, wherein the masks comprise a masking plate having at least one aperture, the reaction vessel being movable with respect to the masking plate.

10. An apparatus according to claim 8, wherein the masks comprise a masking plate having a grid of apertures, the number of which is less than the number of reaction spaces in the vessel.

11. An apparatus according to claim 1, wherein the light detectors have a footprint larger that the footprint of the reaction spaces.

12. An apparatus according to claim 1, wherein the reaction vessel is movably arranged with respect to the light detectors.

13. An apparatus according to claim 1, wherein the light detectors on opposing sides of the reaction vessel are essentially aligned with each other.

14. An apparatus according to claim 1, wherein said feeder comprises a plurality of feeding nozzles each of which is adapted to sequentially feed at least two reaction spaces, which are simultaneously measurable after said feeding by said at least two light detectors.

15. An apparatus according to claim 1, which is adapted to
sequentially apportion second reaction substance to more than two sample spaces using said feeder, and
sequentially measure light from said more than two sample spaces two at a time with said at least two light detectors.

16. An apparatus according to claim 15, wherein each of said more than two sample spaces is adapted to be measured several times.

17. A method for collecting data on a set of light-emitting molecular reactions in the presence of first and second reaction substances, comprising
feeding said second reaction substance to a plurality of reaction spaces of a reaction vessel, the reaction spaces containing said first reaction substance,
measuring light emitted from said reaction spaces, the measuring being synchronized with said feeding,
wherein
said measuring comprises measuring two different properties of the reaction set simultaneously from opposing sides of the reaction vessel.

18. A method according to claim 17, wherein each of the reaction spaces is measured for at least 10 seconds, typically for 15-30 seconds.

19. A method according to claim 17, wherein said second reaction substance comprises biological cells sensitive to said first reaction substance.

20. A method according to claim 17, wherein said first reaction substance comprises photoprotein, such as aequorin, capable of binding to at least one component of said second reaction substance and emitting light due to binding, for example for determining intracellular Ca²⁺ levels.

21. A method according to claim 17, wherein light at different wavelength ranges is measured simultaneously from opposing sides of the reaction vessel.

22. A method according to claim 17, wherein light from different reaction spaces is measured simultaneously from opposing sides of the reaction vessel, respectively.

23. A method according to claims 17, wherein
second reaction substance is fed to a first reaction space,
light is measured from said first reaction space from a first side of the reaction vessel,
second reaction substance is fed to a second reaction space, typically neighboring the first reaction space,
light is measured from said second reaction space from a second side of the reaction vessel,
said measurements are continued simultaneously.

24. A method according to claim 23, wherein between the steps of feeding the reaction vessel is moved with respect to a feeding nozzle used in both said feeding steps.

25. A method according to claims 17, characterized by
initially feeding second reaction substance to a plurality of reaction spaces,
after feeding, measuring light from each of said plurality of reaction spaces for several short measurement periods two at a time from opposing sides of the reaction vessel.
